(19) United States
(12) Patent Application Publication
(10) Pub. No.: US 2011/0135325 A1
(43) Pub. Date: Jun. 9, 2011

(54) IMAGE FORMING SYSTEM

(75) Inventors: Masatoshi HITAKA, Sagamihara-shi (JP); Hiroyuki ARAI, Tokyo (JP); Chikatsu SUZUKI, Tokyo (JP)

(73) Assignee: KONICA MINOLTA BUSINESS TECHNOLOGIES, INC., Tokyo (JP)

(21) Appl. No.: 12/956,389

(22) Filed: Nov. 30, 2010

(30) Foreign Application Priority Data
Dec. 3, 2009 (JP) JP2009-275442
Dec. 8, 2009 (JP) JP2009-278469
Dec. 9, 2009 (JP) JP2009-279219

(51) Int. Cl. G03G 15/20

(52) U.S. Cl. 399/21

(57) ABSTRACT

The present invention realizes an image forming system wherein an efficient cleaning of plural fixing apparatuses by using a blank sheet is attained, the system includes: an image forming section; a sheet feeding apparatus; a plurality of fixing apparatuses; a temperature control section controlling the temperature of the fixing apparatuses; a sheet retention determination section determining whether there is a sheet retained in any of the fixing apparatuses during a jam; and a control section controlling cleaning of the fixing apparatuses by a blank sheet fed from the sheet feeding apparatus, wherein the control section carries out cleaning of the fixing apparatus in which it has been determined that a sheet is retained based on input from the sheet retention determination section, when the temperature of the fixing apparatus has been determined to have reached a prescribed temperature based on input from the temperature control section.

This application is based on Japanese Patent Application No. 2009-275442 filed on Dec. 3, 2009, No. 2009-278469 filed on Dec. 8, 2009, and No. 2009-279219 filed on Dec. 9, 2009 in Japanese Patent Office, the entire content of which is hereby incorporated by reference.

### TECHNICAL FIELD

The present invention relates to an image forming apparatus, specifically relating to an image forming apparatus wherein an efficient cleaning of a plurality of fixing apparatuses by using a blank sheet is provided.

### BACKGROUND OF THE INVENTION

In an electrophographic image forming system, a toner image developed on a photoconductor is transferred onto a sheet, and the toner image is fixed in a fixing apparatus. A roller type fixing apparatus, wherein a sheet with a toner image thereon is nipped in a nip section between a heat roller and a pressure roller (hereinafter, the heat roller and pressure roller are collectively called fixing rollers) and the toner image is fixed onto the sheet by heat and pressure, is most commonly used

A belt-type fixing apparatus, wherein at least either the heat roller or the pressure roller is formed as a belt, is also commonly used as a variant of the roller type fixing apparatus. In the present invention, hereinafter, members which form the nip section such as the heat roller and pressure roller or belt are collectively called fixing members.

When a sheet is jammed in the nip section of such roller type fixing apparatus or belt type fixing apparatus, toner being carried on the sheet adheres onto the fixing members of the fixing apparatus, even after jam treatment, and therefore, the image side and the back side of a subsequent sheet is possibly contaminated by the residual adhered toner when image formation is resumed.

If a cleaning device is equipped with such a fixing apparatus, such contaminating toner is possibly cleaned off by the cleaning device. However, systems, wherein a wax having good releasing characteristics is used as a component of toner to reduce the possibility of jam occurrence, have become more common, and therefore, such cleaning device is not equipped in most cases.

However, if a jam occurred in a fixing apparatus which is not equipped with a cleaning device, or if a jam occurred elsewhere, such as in a conveyance path, and the jam resulted in the retention of a sheet with un-fixed toner thereon at the nip section of the fixing apparatus, contamination by residual adhered toner is possibly occurred. Because the fixing apparatus is subjected to high temperature, it is not recommended for safety reasons to expect the user to clean fixing apparatus.

Therefore, a technique has been proposed such as when a fixing apparatus is contaminated by residual adhered toner due to a jam, a cleaning sheet is passed through the nip section of the fixing apparatus to clean the fixing apparatus by the cleaning sheet. For example, Unexamined Japanese Patent Application Publication No. 2003-98888 (hereinafter referred to as Patent Document 1) discloses a technique that when a jam occurs and there is a possibility that a sheet is nipped in the nip section of a fixing apparatus at the time, a sheet on which an image has not been formed is passed through the nip section of the fixing apparatus in an automatic sheet ejection process after the jam is settled.

Also, Unexamined Japanese Patent Application Publication No. 2005-3784 (hereinafter referred to as Patent Document 2) discloses a technique such that when a cleaning sheet is passed through the nip section of a fixing apparatus to clean the fixing apparatus, the cleaning sheet is conveyed at a slower speed than used for image forming so that the efficiency of cleaning is increased.

As a cleaning sheet, an unused blank sheet, the back side of a printed sheet, or a sheet on which an image suitable to clean the toner adhered to fixing rollers is formed is used. In the present invention, the cleaning method, using these various kinds of sheets to clean the fixing apparatus by passing the sheet through the fixing apparatus, is collectively called as “cleaning by blank sheet”, or “cleaning by sheet through”.

Some image forming systems are configured with a plurality of fixing apparatuses. Fixing apparatus fixes toner onto a sheet by heat. Meanwhile, the sheet absorbs heat from the fixing apparatus. When a material of high heat capacity is used for the heat roller of a fixing apparatus, temperature decrease of the heat roller by the sheets can be reduced. On the other hand, as a drawback, more time is required for warming-up or to heat up the heat roller of which temperature is decreased by the sheets passed through. To overcome the situation, a plurality of fixing apparatuses is used to share the fixing process.

For example, Unexamined Japanese Patent Application Publication No. 2000-221820 discloses a technique such that three fixing apparatuses are arranged in series and a mechanism is provided to close and open the fixing nip section of each fixing apparatus separately so that the fixing apparatus to be used is shared based on the temperature decrease or based on a prescribed number of sheets passed through a fixing apparatus.

Also, Unexamined Japanese Patent Application Publication No. 2000-221821 discloses a technique such that a plurality of fixing apparatuses is arranged in series and the number of fixing apparatus to be used at a time is changed, in recognition that the glossiness of an image on a sheet can be changed by adjusting the amount of heat absorbed by the sheet at fixing, so that the glossiness of the image is controlled.

However, it has not been suggested yet how to perform cleaning of fixing apparatus by blank sheet when a jam occurs in an image forming apparatus which is equipped with a plurality of fixing apparatuses arranged in series.

Furthermore, Unexamined Japanese Patent Application Publication No. 2000-221834 discloses a technique such that a plurality of fixing apparatuses is arranged in parallel and each of the fixing apparatuses is used alternately by passing a sheet to be fixed through each of the fixing apparatuses one after the other, for example, so that heat capacity of each fixing apparatus can be reduced and warm-up time of the fixing apparatuses is shortened. In this constitution, because the interval of sheets passing through each of the fixing apparatuses becomes wider, the heat taken from the fixing apparatus by the sheet is reduced and fixing capability is maintained without reducing productivity, even for a thick sheet, for example.

However, it has not been suggested yet how to perform cleaning of fixing apparatus by a blank sheet when a jam occurs in an image forming system which is equipped with a plurality of fixing apparatuses, being arranged in series or in parallel.

If the method of cleaning by blank sheet, described in Patent Documents 1 and 2, is applied to an image forming system which is equipped with a plurality of fixing apparatuses arranged in series, cleaning by blank sheet is equally carried out to each of the plurality of fixing apparatuses and thus the cleaning process is inefficient and uneconomical.

Because cleaning by blank sheet is achieved by transferring residual toner adhered to fixing rollers onto a sheet, it is required that the fixing rollers be heated to a certain level of temperature to melt and soften the toner to be transferred onto the sheet. However, the temperature of each of the fixing rollers of a plurality of fixing apparatuses is different depending on the state at the time of system shutdown, it requires a longer time to carry out cleaning by blank sheet if waiting until the temperature of the fixing rollers of all fixing apparatuses is increased to a specified temperature. It is not an efficient way to carry out cleaning by blank sheet. Also, it is not efficient to wait until the temperature of the fixing rollers of a fixing apparatus in which a sheet is not retained at the nip section thereof is increased to the level of temperature.

### SUMMARY OF THE INVENTION

The present invention has been made in consideration of the above problems, and it is one of the main objects to provide an image forming system which is equipped with a plurality of fixing apparatuses, wherein an efficient cleaning by blank sheet is attained by initiating the cleaning by determining if the temperature of the fixing apparatus, where there is a possibility that a sheet is retained at the nip section of the fixing apparatus, to reach a certain temperature.

The above object of the present invention was achieved employing the following constitutions.

(1) An image forming system reflecting one aspect of the present invention includes, for example: an image forming section; a sheet feeding apparatus; a plurality of fixing apparatuses located downstream of the image forming section; a temperature control section which measures and controls the temperature of each of the plurality of fixing apparatuses; a sheet retention determination section which determines whether or not there is a possibility in which during a jam occurrence, a sheet is retained in the nip section of each of the plurality of fixing apparatuses; and a control section which controls cleaning of a fixing apparatus by passing a blank sheet through the fixing apparatus, wherein the control section carries out the cleaning, after a jam has been cleared is settled, of the fixing apparatus, which is determined by the sheet retention determination section that there is a possibility in which a sheet is retained, by passing a sheet through the fixing apparatus, the sheet fed from the sheet feeding apparatus when the temperature of the fixing apparatus is determined to have reached a first prescribed temperature based on an input from the temperature control section.
(2) The image forming system of item 1, wherein the control section carries out cleaning of the fixing apparatus which is determined by the sheet retention determination section that there is not a possibility in which a sheet is retained, by passing a sheet through the fixing apparatus, the sheet fed from the sheet feeding apparatus when the temperature of the fixing apparatus is determined, based on an input from the temperature control section, to have reached a second prescribed temperature which is lower than the first prescribed temperature.
(3) The image forming system of item 1, wherein the first prescribed temperature is different from a fixable temperature of the fixing apparatus which is determined by the sheet retention determination section that there is a possibility in which a sheet is retained.
(4) The image forming system of item 1, wherein the second prescribed temperature is a rotation permission temperature of the fixing apparatus which is determined by the sheet retention determination section that there is a possibility in which a sheet is retained.
(5) The image forming system of item 1, wherein the control section controls a sheet to be used for cleaning to be conveyed through the image forming section without forming an image on the sheet.

According to the above aspect of the present invention, when a jam occurs in an image forming system which is equipped with a plurality of fixing apparatuses, an efficient cleaning by blank sheet is attained because the cleaning can be initiated to the fixing apparatus which has been determined that there is a possibility in which a sheet is retained at the nip section of the fixing apparatus, without waiting for a raise in temperature of the remaining fixing apparatus/apparatuses.

Contamination by residual adhered toner does not occur at a fixing apparatus in which a sheet is not retained at the nip section of the fixing apparatus. Therefore, it is not economical to carry out cleaning by blank sheet to all of the plurality of fixing apparatus including the fixing apparatus in which a sheet is not retained. Also, there is a possibility that, if a sheet used for cleaning of a fixing apparatus contaminated by residual adhered toner and the sheet is fed through fixing apparatus/apparatuses located downstream of the fixing apparatus, the residual toner transferred on the sheet may adhere again to a fixing apparatus downstream, which was not contaminated.

It is another object of the present invention to provide an image forming system which is equipped with a plurality of fixing apparatus wherein both an efficient cleaning by blank sheet and cleaning without occurrence of re-contamination by the sheet used for the cleaning are attained. To achieve this object, a bypass conveyance path is provided between fixing apparatuses so that a sheet, passed through a fixing apparatus for cleaning is branched off from the conveyance path between the fixing apparatus and a fixing apparatus downstream to the bypass conveyance path to be discharged. If there is a possibility that a sheet is retained at the nip section of a fixing apparatus upstream, cleaning by blank sheet is carried out in the fixing apparatus upstream and the sheet used for the cleaning is discharged via the bypass conveyance path. If there is a possibility that a sheet is retained at the nip section of a fixing apparatus downstream, then the sheet used for cleaning by blank sheet is simply passed though the fixing apparatus upstream and is passed through the fixing apparatus downstream to clean the fixing apparatus-downstream. If there is a possibility that a sheet is retained in both of the fixing apparatuses upstream and downstream, then the sheet used for cleaning by blank sheet is passed through the fixing apparatus upstream and is discharged via the bypass conveyance path, and then, another sheet for cleaning by blank sheet is fed to carry out the cleaning of the fixing apparatus downstream.

The above object of the present invention was achieved employing the following constitutions.

(1) An image forming system reflecting one aspect of the present invention includes, for example: an image forming section; a sheet feeding apparatus; a plurality of fixing apparatuses located downstream of the image forming section; one, or a plurality of bypass conveyance paths which is located downstream of each of the plurality of fixing apparatuses, except for a fixing apparatus located most downstream, to branch off a sheet leading toward to a discharge opening; a sheet retention determination section which determines whether or not there is a possibility in which during a jam occurrence, a sheet is retained at the nip section of each of the plurality of fixing apparatuses; and a control section which controls cleaning of a fixing apparatus by passing a blank sheet through the fixing apparatus, wherein the control section carries out the cleaning of the fixing apparatus, which is determined by the sheet retention determination section that there is a possibility in which a sheet is retained, by passing a sheet through the fixing apparatus and the control section controls the sheet passed through the fixing apparatus to be branched off to one or the plurality of bypass conveyance paths, to be then discharged.
(2) The image forming system of item 1, wherein when the sheet retention determination section determines the number of fixing apparatuses where a sheet is retained is one, and if there is another one or a plurality of fixing apparatuses upstream of the fixing apparatus, the control section controls a sheet to be used for the cleaning of the fixing apparatus by passing the sheet through one or the plurality of fixing apparatuses upstream of the fixing apparatus, and if there is another one or a plurality of fixing apparatuses downstream, the control section controls the sheet used for the cleaning to be branched off to one or the plurality of bypass conveyance paths so that the sheet is discharged without passing through one or the plurality of fixing apparatuses downstream.
(3) The image forming system of item 1, wherein when the sheet retention determination section determines the number of fixing apparatus where a sheet is retained is two or more, the control section controls the cleaning by passing a sheet for the cleaning first through the fixing apparatus being located most upstream among the fixing apparatuses determined that a sheet is retained, and the control section controls the sheet used for the cleaning to be branched off to one or the plurality of bypass conveyance paths, to be discharged without passing the sheet through one or the plurality of fixing apparatuses downstream. Then, the control section carries out the cleaning of the fixing apparatus which has been determined that a sheet is retained and located to be next most upstream. In such a manner, the control section carries out the cleaning of all the fixing apparatuses which are determined that a sheet is retained.
(4) The image forming system of item 1, wherein the control section controls a sheet to be used for the cleaning to be conveyed through the image forming section without forming an image on the sheet.
(5) The image forming system of item 1, wherein if the thickness of a sheet to be used for the cleaning is more than or equal to a prescribed thickness, the control section controls the sheet used for the cleaning of a fixing apparatus to be passed through one or the plurality of fixing apparatuses being located downstream of the fixing apparatus without using one or the plurality of bypass conveyance paths.

According to the above aspects of the present invention, both an efficient cleaning by blank sheet and cleaning without occurrence of re-contamination by the transferred residual toner, on the sheet used for the cleaning, are attained by configuring the image forming system to carry out cleaning by blank sheet to the fixing apparatus, which has been determined that a sheet was retained, and discharge the sheet used for the cleaning via a bypass conveyance path.

### BRIEF DESCRIPTION OF THE DRAWINGS

FIG. 1 is a central sectional view of an image forming system to which the present invention is applied.

FIG. 2 shows a view schematically illustrating the operation of two fixing apparatuses according to the present invention.

FIG. 3 shows a state in which a jammed sheet is retained in first fixing apparatus 20a.

FIG. 4 shows a state in which a jammed sheet is retained in second fixing apparatus 20b.

FIG. 5 is a block diagram schematically illustrating the control configuration to execute the control of the present invention.

FIG. 6 is a flowchart showing the control program in a first embodiment of the present invention.

FIG. 7 is a flowchart showing the control program in the first embodiment of the present invention.

FIG. 8 shows an operation panel of the present invention.

FIG. 9 is a flowchart showing the control program in a second embodiment of the present invention.

FIG. 10 is a flowchart showing the control program in a third embodiment of the present invention.

FIG. 11 is a flowchart showing the control program in a forth embodiment of the present invention.

FIG. 12 is a flowchart showing the control program in a fifth embodiment of the present invention.

FIG. 13 is a flowchart showing the control program in the fifth embodiment of the present invention.

FIG. 14 shows an operation panel of the present invention.

FIG. 15 shows an operation panel of the present invention.

### DETAILED DESCRIPTION OF THE PREFERRED EMBODIMENTS

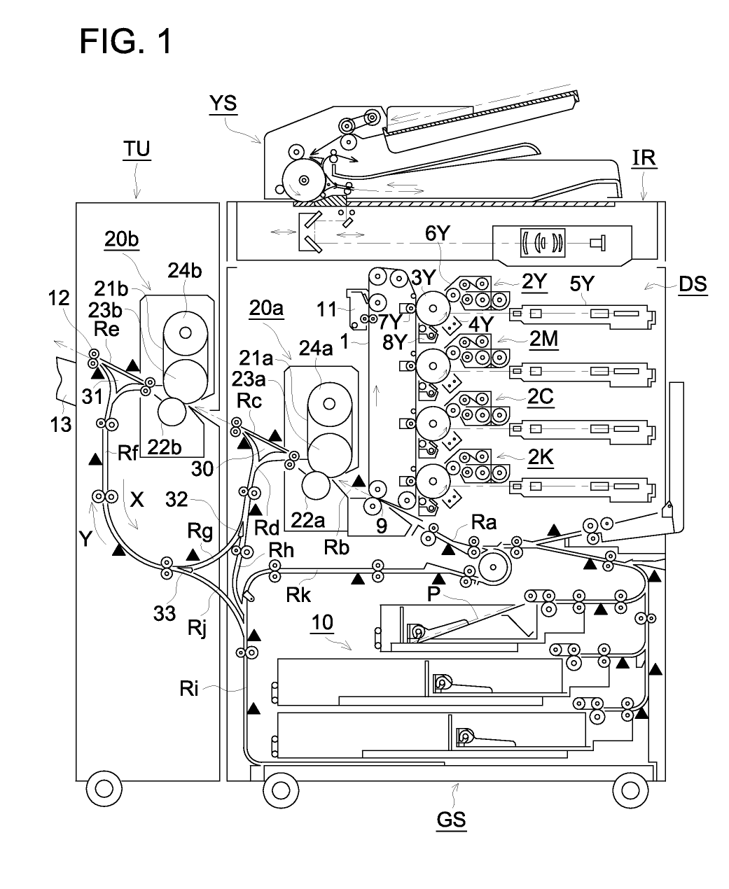

The present invention will now be described with reference to drawings. FIG. 1 is a central sectional view of an image forming system to which the present invention is applied. This image forming system is a color machine of a tandem system. Herein, needless to say, the present invention can be applied to any color machines and monochrome machines employing other systems.

The image forming system incorporates image forming apparatus GS in the center, automatic document feeder YS placed on top thereof; and second fixing unit TU. These are constituted as separate bodies and then built up at the installation site of the system, but a united constitution thereof may be employed.

Image forming apparatus GS has image forming section DS incorporating intermediate transfer belt 1 wound in a vertically long manner, as well as image forming unit yellow 2Y, image forming unit magenta 2M, image forming unit cyan 2C, and image forming unit black 2B arranged on the right side thereof.

Since the constitution of each image forming unit is the same, only image forming unit yellow 2Y will be described. At the left end of the unit, photosensitive drum yellow 3Y is arranged so as to be in contact with intermediate transfer belt 1. Around photosensitive drum yellow 3Y, charging device yellow 4Y, laser writing device yellow 5Y, developing apparatus yellow 6Y, first transfer roller yellow 7Y (on the rear side of intermediate transfer belt 1), and cleaning apparatus yellow 8Y are sequentially arranged counterclockwise. In the following description, the section number without Y, M, C, or Bin each apparatus or device is common to each color.

Beneath automatic document feeder YS, image reading apparatus IR is arranged. The image of an original document having been fed to the reading position by automatic document feeder YS or the image of an original document having been placed on the document platen is read by image reading apparatus IR to be fed to laser writing device 5.

Photosensitive drum 3 is uniformly charged by charging device 4 and thereafter an image is written thereon by laser writing device 5. Thus, an electrostatic latent image is formed on photosensitive drum 3. This electrostatic latent image is converted into a toner image by developing apparatus 6 and then the toner image is transferred onto intermediate transfer belt 1 by first transfer roller 7.

The toner image of each color is superimposed on intermediate transfer belt 1 and thereafter the resulting toner image is transferred by second transfer roller 9 onto a sheet having been fed from sheet feeding apparatus 10. Intermediate transfer belt 1 after transfer is cleaned by belt cleaning apparatus 11.

The toner image having been transferred on the sheet is fixed by a fixing apparatus. The image forming system shown has first fixing apparatus 20a and second fixing apparatus 20b arranged in series. Second fixing apparatus 20b is arranged in second fixing unit TU described above.

The purposes that 2 fixing apparatuses are provided are to realize excellent fixing performance by applying adequate heat and pressure to a sheet and to produce the effect of acceleration of the warming-up time more than the same effect produced by only a single fixing apparatus. Further, such an application of adequate heat and pressure to the sheet makes it possible to realize an increase in glossiness.

Both first and second fixing apparatuses 20a and 20b have fixing belts 21a and 21b on the upper side and pressure rollers 22a and 22b on the lower side, respectively. Further, fixing belts 21a and 21b are wound around support rollers 23a and 23b, and heat rollers 24a and 24b, respectively. In each of heat rollers 24a and 24b, a heater is arranged. The fixing temperatures of the fixing apparatuses are controlled differently from each other by each image forming mode as described later. Further, also in cleaning by blank sheet according to the present invention, the control for different temperatures is carried out.

Next, sheet conveyance paths are described. Sheet feeding apparatus 10 has sheet feed trays of a triple-decker each accommodating sheets of different size, thickness, and type. A selected sheet is sent by each sheet feed roller, passed through conveyance path 1 Ra, and reached at the transfer position, and a toner image is transferred onto the sheet. The sheet on which the toner image has been transferred is passed through conveyance path 2 Rb and then moved toward first fixing apparatus 20a.

In the conveyance path between first fixing apparatus 20a and second fixing apparatus 20b, conveyance path branching member 30 is placed. A sheet is allowed to move toward either straight conveyance path Rc leading toward second fixing apparatus 20b or bypass conveyance path Rd leading downward.

In the conveyance path downstream of second fixing apparatus 20b, conveyance path branching member 31 is placed. A sheet is allowed to move toward either straight conveyance path Re leading toward exit roller 13 from exit roller 12 or bypass conveyance path Rf leading downward.

Bypass conveyance path Rd is provided with conveyance path branching member 32 and branched into bypass exit path Rg and bypass reversing path Rh. Bypass exit path Rg joins bypass conveyance path Rf extending downward from second fixing apparatus 20b. A sheet is discharged from exit roller 12 onto exit tray 13. Namely, bypass conveyance path Rf is constituted to be drivable in the arrow X direction where a sheet is returned from second fixing apparatus 20b and in the arrow Y direction where a sheet from first fixing apparatus 20a is discharged.

On the other hand, bypass reversing path Rh joins reversing path Ri located below the same. Further, a sheet traveling in the arrow X direction through bypass conveyance path Rf is passed through bypass conveyance path Rj via conveyance path branching member 33 placed at the branching off point to join reversing path Ri. Thereafter, the sheet having entered reversing path Ri advances until the rear edge thereof completely enters reversing path Ri. Then, the sheet is moved in the opposite direction and passed through double-sided conveyance path Rk to join conveyance path 1 Ra. Thereafter, a toner image is transferred onto the rear surface of the sheet.

Further, in the sheet conveyance paths, a plurality of sheet sensors SS (represented by solid black triangle symbols as shown in FIG. 1) are arranged. Thereby, jam occurrence is judged by whether or not a sheet has reached sheet sensor SS in a predetermined time, or by whether or not a sheet has passed through sheet sensor SS in a predetermined time. Still further, sheet sensors SS can also detect the stagnant location of a sheet other than a jammed sheet in the conveyance paths.

From the standpoint of the present invention, an arrangement of retention sensors which directly detect whether or not a sheet is retained at the nip section of fixing apparatus can be applied in addition to a usual arrangement of sheet sensors for jam detection.

In the present invention, via detection by sheet sensors SS, made is judgment whether or not there is a possibility in which during a jam occurrence, a sheet is retained in the nip section of each fixing apparatus. Based on this judgment, cleaning by blank sheet is controlled.

Routes, in which a sheet having been discharged from first fixing apparatus 20a described above is passed through the above conveyance paths, are summarized with respect to the single-sided mode and the double-sided mode.

The following 6 routes are employed:

Single-sided straight exit: 20a→Rc→20b→Re

Single-sided bypass exit: 20a→Rd→Rg→Rf→Re

Double-sided conveyance 1 straight exit: 20a→Rd→Rh→Ri→Rk→Ra→Rb→20a→Rc→20b→Re

Double-sided conveyance 1 bypass exit: 20a→Rd→Rh→Ri→Rk→Ra→Rb→20a→Rd→Rg→Rf→Re

Double-sided conveyance 2 straight exit: 20a→Rc→20b→Rf→Rj→Ri→Rk→Ra→Rb→20a→Rc→20b→Re

Double-sided conveyance 2 bypass exit: 20a→Rc 20b→Rf→Rj→Ri→Rk→Ra→Rb→20a→Rd→Rg→Rf→Re

Herein, “straight exit” refers to a conveyance mode in which a sheet is fixed by both first fixing apparatuses 20a and 20b and then discharged, and “bypass exit” refers to a conveyance mode in which a sheet is fixed only by first fixing apparatus 20a and then discharged.

Further, “double-sided conveyance 1” refers to a mode in which in the double-sided mode, the surface of a sheet is fixed only by first fixing apparatus 20a and then returned to the double-sided conveyance path to carry out image formation on the rear surface. “Double-sided conveyance 2” refers to a mode in which in the double-sided mode, the surface of a sheet is fixed by both fixing apparatuses 20a and 20b and then returned to the double-sided conveyance path. Further, in the double-sided mode, depending on the type of sheet, an appropriate combination is made with either the straight exit or the bypass exit.

The selection of such conveyance paths is carried out in combinations of the single-sided/double-sided modes with the thickness and type of a sheet.

The thickness and type of a sheet are selected based on the following criteria.

In the double-sided mode, the surface is basically passed only through first fixing apparatus 20a and the rear surface is passed through both fixing apparatuses 20a and 20b. The reason is that for the surface, even loose fixing to the extent that no toner is peeled produces no problem since heating is applied thereto during rear surface fixing.

With regard to the criteria for the thickness and type of a sheet, a sheet being thick is passed through both fixing apparatus 20a and 20b, but a sheet being thin is passed only through first fixing apparatus 20a. The reason is that since thin sheet exhibits low heat capacity, even only first fixing apparatus 20a can realize adequate fixing. Further, in cases where the type of a sheet is label paper or an OHP, sheet feeding to 2 fixing apparatuses may cause damage to the sheet. In such a case, fixing is carried out only by first fixing apparatus 20a.

In the embodiments of the present invention, a constitution is made to produce most excellent fixing effects by combination of conveyance path branching depending on the paper thickness and type of a sheet as described above with the fixing temperature control of first fixing apparatus 20a and second fixing apparatus 20b. Table 1 shows examples of the fixing temperatures of fixing apparatuses 20a and 20b depending on the thickness and type of a sheet.

TABLE 1

| | Basic Weight of | | Basic Weight of | |
|---|---|---|---|---|
| | at most 105 g/m² | | at least 106 g/m² | |
| | Coated | Other than | Coated | Other than |
| | paper | coated paper | paper | coated paper |
| First fixing | 165° C. | 170° C. | 175° C. | 180° C. |
| apparatus 20a | | | | |
| Second fixing | 160° C. | 160° C. | 160° C. | 170° C. |
| apparatus 20b | | | | |

In Table 1, for a sheet having excessive thickness (basic weight), the fixing temperature of first fixing apparatus 20a is set high, and the sheet type is divided into coated paper and other types. The fixing temperature for coated paper is set low. For coated paper, since the paper surface is coated with a coating material, the fixing temperature is set lower to a small extent than that for those other than coated paper so that heat via fixing produces no adverse effect to the sheet.

Further, the fixing temperature of second fixing apparatus 20b is set lower than that of first fixing apparatus 20a. The reason for the above setting is as follows: since all the sheets are passed through first fixing apparatus 20a, the temperature is set for adequate fixing, and in contrast, second fixing apparatus 20b functions to complement the fixing of a sheet having been fixed by first fixing apparatus 20a and to further enhance glossiness for finishing.

In the image forming system having been described above, the control of cleaning by blank sheet after jam treatment will now be described.

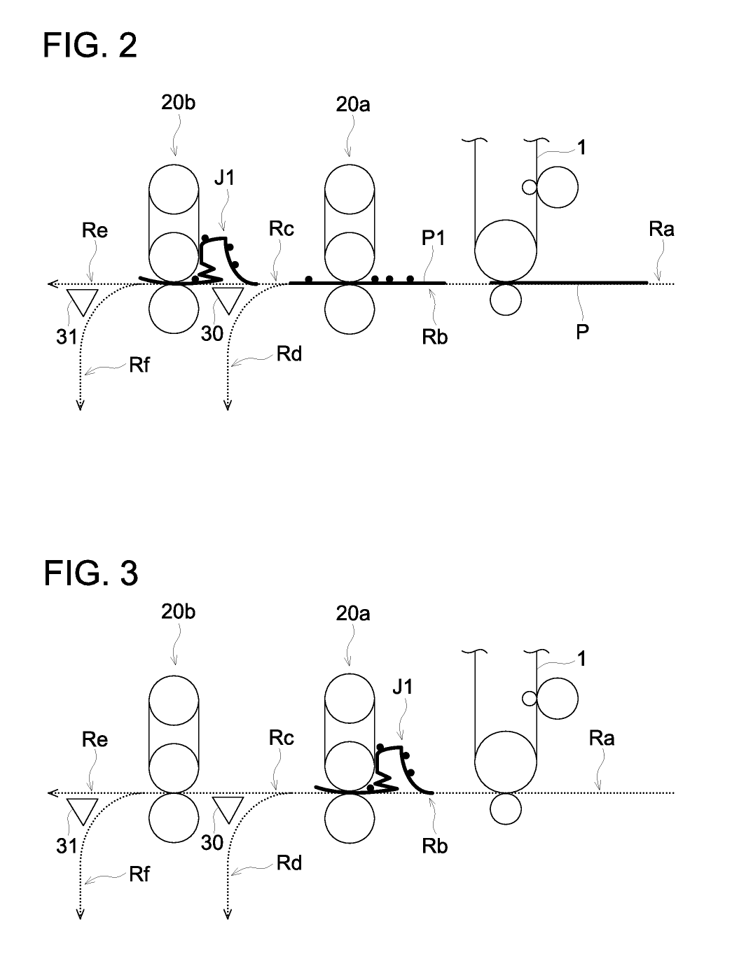

FIG. 2 shows a view schematically illustrating the operation of two fixing apparatuses 20a and 20b according to the present invention, showing the state where the image forming system has been shut down due to a jam occurrence in second fixing apparatus 20b. It is shown that when the system has been shut down, sheet P1 upstream of jammed sheet J1 has also been stopped at the position of first fixing apparatus 20a. Upstream of sheet P1, sheet P on which no image has yet been formed is also retained.

At this moment, an unfixed toner on jammed sheet J1 is pressed to the fixing belt, resulting in fixing belt contamination. Further, an unfixed toner on sheet P1 being not jammed but retained in the nip section of first fixing apparatus 20a is also in the state of adhering to the fixing belt.

From such a state, even if the user carries out jam treatment to remove sheets J1, P1, P, the toner having adhered to the fixing belt remains the same, and thereby, when image formation is resumed, a newly-fed sheet is contaminated. Therefore, to remove the toner having adhered to this fixing belt, before resuming image formation, a blank sheet to be subjected to no image formation is passed through the nip section of the fixing apparatus for cleaning by blank sheet.

In the present invention, the fixing temperature for cleaning by blank sheet differs from the fixing temperature for image formation. Namely, when the temperatures of first fixing apparatus 20a and second fixing apparatus 20b reach temperatures described below, cleaning by blank sheet is carried out. However, without waiting until the temperatures of both fixing apparatuses reach the temperatures described below, when the temperature of a fixing apparatus in which a sheet is retained, namely, a fixing apparatus to be subjected to cleaning by blank sheet reaches the following blank sheet cleaning permission temperature, cleaning by blank sheet is initiated.

First fixing apparatus 20a: 180° C.

Second fixing apparatus 20b: 165° C.

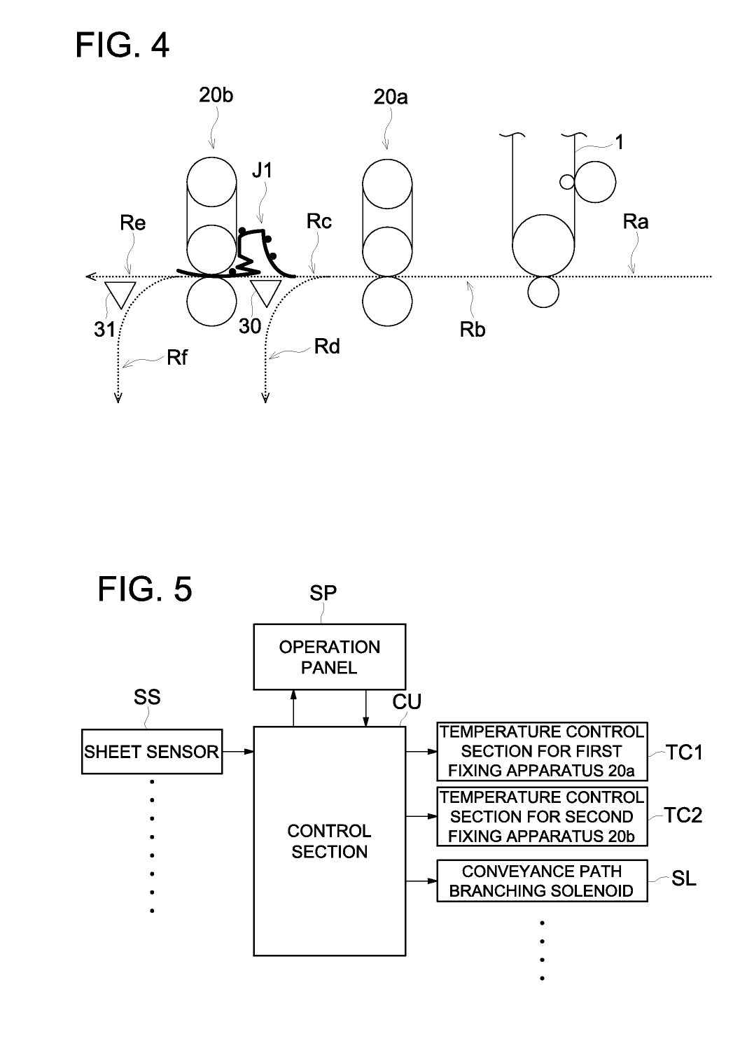

FIG. 3 shows a state in which a jammed sheet is retained in first fixing apparatus 20a and FIG. 4 shows a state in which a jammed sheet is retained in second fixing apparatus 20b. In cases where a sheet is retained in first fixing apparatus 20a, when the temperature of first fixing apparatus 20a reaches 180° C., cleaning by blank sheet is initiated. Since no cleaning is required for second fixing apparatus 20b, the cleaning sheet is discharged through the route of the single-sided bypass exit.

On the other hand, in cases where a sheet is retained in second fixing apparatus 20b, no cleaning is required for first fixing apparatus 20a. Therefore, even when the temperature of first fixing apparatus 20a has not reached 180° C., cleaning by blank sheet is initiated when the temperature of second fixing apparatus 20b reaches 165° C. In this case, the route of the conveyance path is the single-sided straight exit.

Further, when sheets are retained in both first fixing apparatus 20a and second fixing apparatus 20b, initially, cleaning by blank sheet is carried out in first fixing apparatus 20a for the bypass exit and thereafter, cleaning by blank sheet is carried out in second fixing apparatus 20b.

FIG. 5 is a block diagram schematically illustrating the control configuration to execute the control of the present invention. Control section CU has a conventionally well-known CPU, a memory and an IO gate. Signals from a plurality of sheet sensors SS placed in the conveyance paths are input into control section CU, which outputs control signals to temperature control section TC1 for first fixing apparatus 20a, temperature control section TC2 for second fixing apparatus 20b, and each conveyance path branching solenoid SL to operate a plurality of conveyance path branching members 30, 31, 32, and 33. Signals from the plurality of sheet sensors SS input into control section CU are also used at a sheet retention determination section part (not shown) of control section CU to determine whether or not there is a possibility that a sheet is retained in a fixing apparatus during a jam occurrence.

Further, temperature control section TC1 for first fixing apparatus 20a and temperature control section TC2 for second fixing apparatus 20b contain a temperature sensor (not shown) to determine the temperature of each fixing apparatus, and the temperature control is carried out based on the determined temperature by this temperature sensor.

Still further, control section CU is connected to operation panel SP, receiving an input signal from operation panel SP to output a signal with respect to contents to be displayed. Herein, to control the entire image forming system, control section CU is connected with various types of devices unshown. However, FIG. 5 shows only those relating to the present invention.

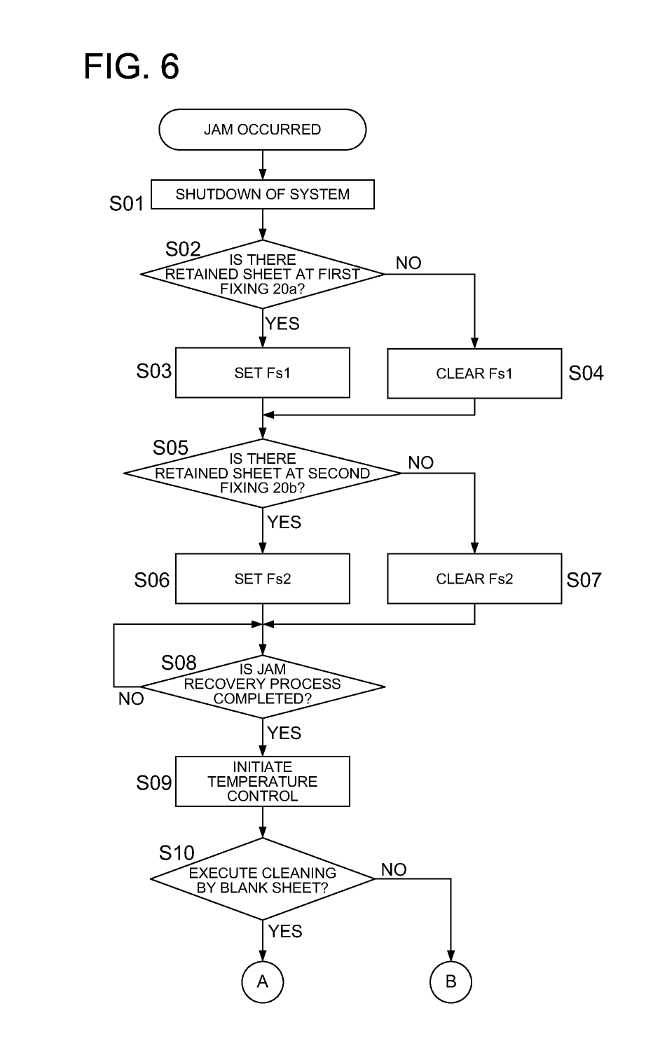

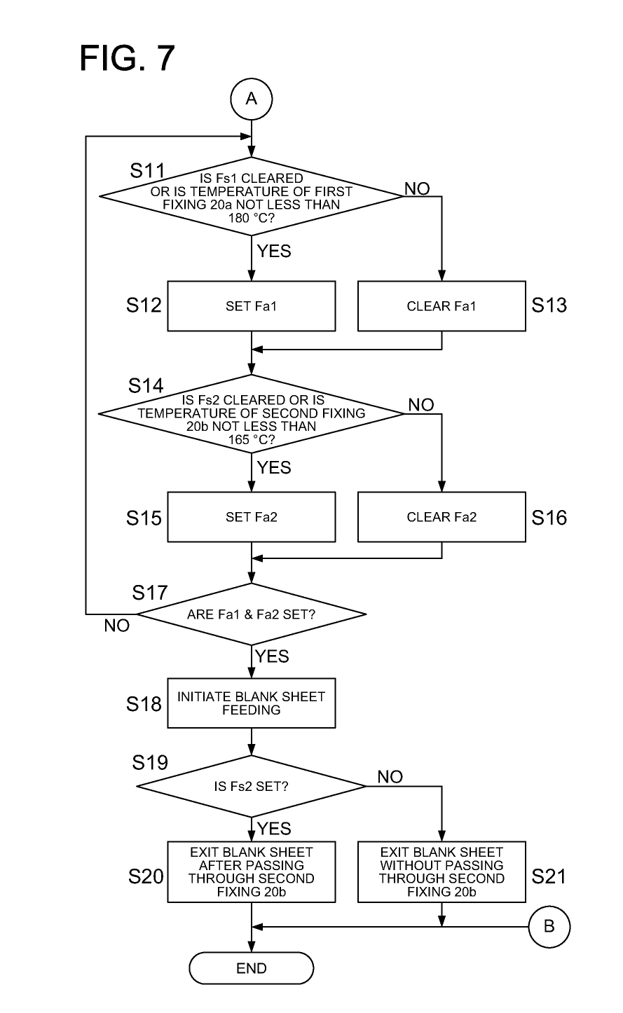

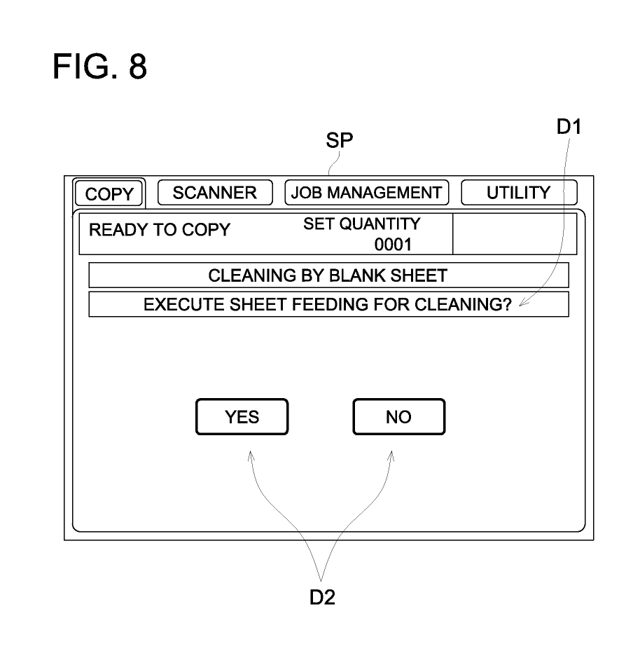

FIGS. 6 and 7 are each a flowchart showing the control program carried out by control section CU from jam occurrence to cleaning by blank sheet in a first embodiment of the present invention. Herein, the wordings in each flowchart are simplified.

Incidentally, temperature control section, sheet retention determination section, and control section for cleaning by blank sheet described in the specification incorporate relevant functional parts of this control program as well as relevant sensors and devices.

At the moment when jam occurs, this program is initiated. Initially, in step S01, the image forming system is shut down. Then, from a signal from sheet sensor SS on shutdown, whether or not a sheet is retained in first fixing apparatus 20a is judged (step S02). When a sheet is present therein, sheet retention flag Fs1 for first fixing apparatus 20a is set (step S03). In contrast, when no sheet is present, sheet retention flag Fs1 for first fixing apparatus 20a is cleared (step S04).

In the same manner, whether or not a sheet is retained in second fixing apparatus 20b is judged. Based on the presence or absence of a sheet, sheet retention flag Fs2 for second fixing apparatus 20b is set or cleared (steps S05 to S07).

Then, at step S08, the completion of jam treatment by the user is awaited, and then after completion, the temperature control of first fixing apparatus 20a and second fixing apparatus 20b is initiated. At this moment, control section CU outputs the above blank sheet cleaning permission temperatures to first fixing apparatus 20a and second fixing apparatus 20b to carry out control for the relevant temperatures.

Subsequently, at step S10, whether or not cleaning by blank sheet is carried out is confirmed to the user. The user can visually observe the contamination state of the fixing apparatus in jam treatment, whereby in the case of little contamination occurrence, transition to normal formation of an image can be made without cleaning by blank sheet.

This confirmation is made under the condition that either sheet retention flag Fs1 for first fixing apparatus 20a or sheet retention flag Fs2 for second fixing apparatus 20b is set, namely, a sheet is retained in either of the fixing apparatuses. Display D1 of “EXECUTE CLEANING BY BLANK SHEET?” for operation panel SP and button display D2 of “YES” or “NO” for the touch panel section are carried out. When the pressed button is for “NO”, the advance of B in FIG. 6→B in FIG. 7 is made to terminate the present program.

When the pressed button is for “YES”, made is judgment whether or not sheet retention flag Fs1 for first fixing apparatus 20a is in the cleared state at step S11 or the temperature of first fixing apparatus 20a has reached a blank sheet cleaning permission temperature of at least 180° C.

At step S11, in the case of “YES”, blank sheet cleaning permission flag Fa1 for first fixing apparatus 20a is set (step S12). In the case of “NO”, blank sheet cleaning permission flag Fa1 is cleared (step S13).

In the same manner, made is judgment whether or not sheet retention flag Fs2 for second fixing apparatus 20b is in the cleared state at step S14 or the temperature of second fixing apparatus 20b has reached a blank sheet cleaning permission temperature of at least 165° C. In the case of “YES” at step S14, blank sheet cleaning permission flag Fa2 for second fixing apparatus 20b is set (step S15). In the case of “NO”, blank sheet cleaning permission flag Fa2 is cleared (step S16).

Then, at step S17, the state where both blank sheet cleaning permission flags Fa1 and Fa2 for fixing apparatuses 20a and 20b have been set is awaited and then the advance to step S18 is made to initiate blank sheet feeding.

The state where both blank sheet cleaning permission flags Fa1 and Fa2 are in the set state at step S17 refers to the case where the temperature of first fixing apparatus 20a has reached a control temperature of at least 180° when a sheet is retained in first fixing apparatus 20a; and to the case where the temperature of second fixing apparatus 20b has reached a control temperature of at least 165° when a sheet is retained in second fixing apparatus 20b. At this moment, even if the temperature of the other fixing apparatus has not reached the control temperature, cleaning by blank sheet is carried out.

Cleaning by blank sheet is initiated at step S18 and then at step S19, based on the state of sheet retention flag Fs2 for second fixing apparatus 20b, whether a sheet is fed to second fixing apparatus 20b (step S20) or no sheet is fed thereto (step S21) is determined to terminate the flowchart. In response to the determination at step S19, Control Section CU controls the conveyance path branching members for the straight exit or bypass exit.

Next a second embodiment of the present invention will be described. The structure of the image forming system of the second embodiment is the same as the structure described in the first embodiment, thus the description is omitted, and the operation of the second embodiment is described. In the second embodiment, a control is described for a case wherein the rotation of fixing rollers is not allowed until the temperature of the fixing rollers has reached a prescribed temperature. When the image forming system is in pre-boot stage or operation is shut down due to a jam occurrence, etc., electric power is not applied to the fixing apparatuses, and therefore, the fixing belt and the heat roller are contacting each other at a low temperature. At the state, the pressure roller presses the fixing belt and the pressure makes a dent at the nip portion. If the rotation of the roller and belt is initiated in this state, the dent may possibly damage the pressure roller or other members.

The second embodiment of the present invention is an example case wherein a rotation permission temperature is set and the fixing rollers of fixing apparatus are not allowed to rotate until the temperature of the rollers has reached at least the rotation permission temperature. Needless to say, operation of cleaning by blank sheet is in a standby state until the temperature of the fixing apparatus has reached at least the rotation permission temperature. In the second embodiment, the rotation permission temperature for both first fixing apparatus 20a and second fixing apparatus 20b is set at 100° C.

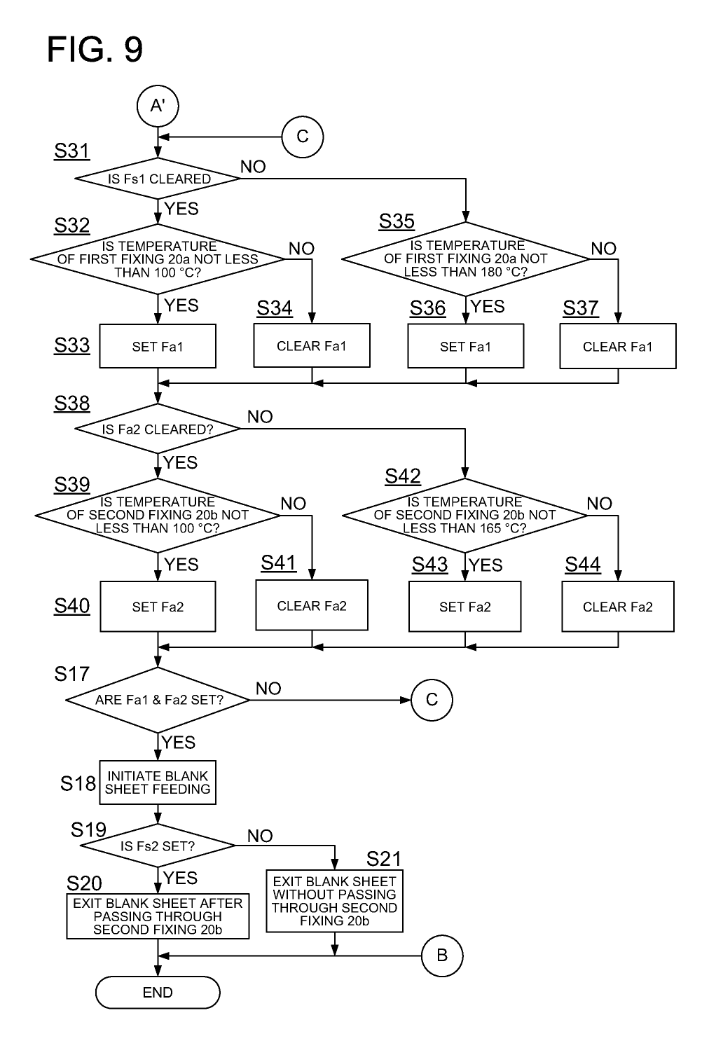

FIG. 9 is a flowchart showing the control program in the second embodiment. After step S10 in FIG. 6, the advance to A′ in FIG. 9 is made instead of the advance to A in FIG. 7. The different steps in FIG. 9 from the steps in FIG. 7 are indicated by underlined step numbers.

At step S31 in FIG. 9, made is judgment whether or not sheet retention flag Fs1 for first fixing apparatus 20a is cleared. If Fs1 is cleared, then at step S32, made is judgment whether or not the temperature of first fixing apparatus 20a is at least the rotation permission temperature of 100° C. If the result is “YES”, blank sheet cleaning permission flag Fa1 for first fixing apparatus is set (step S33). If the result is “NO”, blank sheet cleaning permission flag Pa1 for first fixing apparatus is cleared (step S34).

In case of “NO” at step S31, the advance to step S35 is made, and made is judgment whether or not the temperature of first fixing apparatus 20a is at least the blank sheet cleaning permission temperature of 180° C. If the result is “YES”, blank sheet cleaning permission flag Fa1 for first fixing apparatus is set (step S36). If the result is “NO”, blank sheet cleaning permission flag Fa1 for first fixing apparatus is cleared (step S37).

Next, at step S38, made is judgment whether or not sheet retention flag Fs2 for second fixing apparatus 20b is cleared. In the same manner as in the case of sheet retention flag Fs1 for first fixing apparatus 20a, based on the judgment of whether or not the temperature of second fixing apparatus 20b is at least the rotation permission temperature of 100° C. and the judgment of whether or not temperature of second fixing apparatus 20b is at least the blank sheet cleaning permission temperature of 165° C., blank sheet cleaning permission flag Fa2 for second fixing apparatus is either set or cleared (steps S39 to S44).

The steps after step S17, where made is judgment whether or not both of blank sheet cleaning permission flags Fa1 and Fa2 are set, are the same as steps in FIG. 7.

In the second embodiment, judgment on the rotation permission temperature is made in addition to judgment on the blank sheet cleaning permission temperature of the fixing apparatus where a sheet is retained. Therefore, the embodiment makes it possible not only to reduce the time for carrying out cleaning by blank sheet, but also to avoid scarring caused by rotation of fixing rollers at a low temperature.

Next a third embodiment of the present invention is described. In the previously described embodiment, bypass conveyance paths are provided between first fixing apparatus 20a and second fixing apparatus 20b. In the third embodiment, an image forming system without bypass conveyance is assumed. Namely, any sheets should always be passed through both first fixing apparatus 20a and second fixing apparatus 20b in the image forming system.

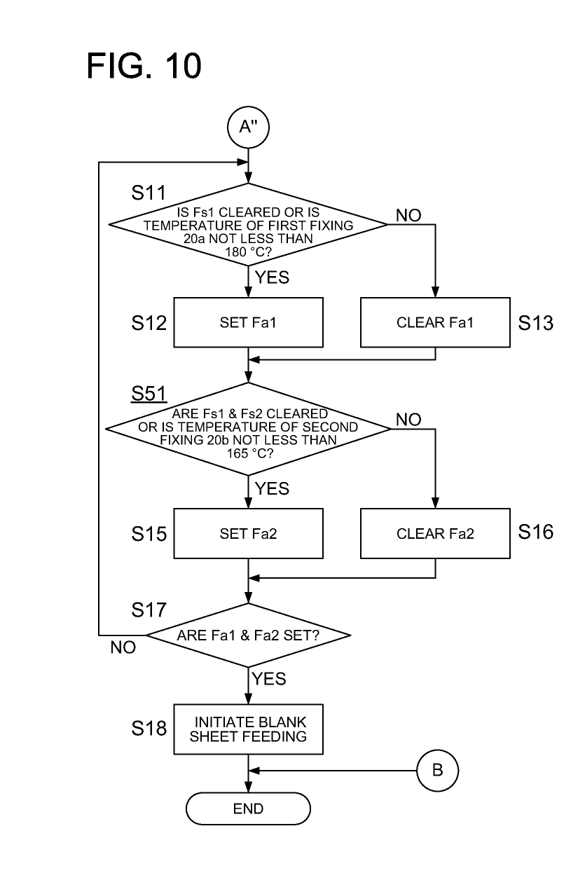

The third embodiment shows a control for the case explained above, and the advance from step S10 in FIG. 6 to A″ in FIG. 10 is made in stead of the advance to A in FIG. 7. In FIG. 10, step S14 in FIG. 7 is changed to step S51, and steps 19 to S21 in FIG. 7 are omitted.

The result of judgment at step S51 is “YES” if both sheet retention flag Fs1 for first fixing apparatus 20a and sheet retention flag Fs2 for second fixing apparatus 20b are cleared, or the temperature of second fixing apparatus 20b is at least the blank sheet cleaning permission temperature of 165° C. If “YES”, the advance to step S15 is made and blank sheet cleaning permission flag Fa2 is set.

Then, under the condition that both blank sheet cleaning permission flags Fa1 and Fa2 are in the set state (step S17), cleaning by blank sheet is initiated.

Blank sheet cleaning permission flag Fa1 is set if the result of step S11 is “YES”, namely, Fa1 is set if a sheet is not retained at first fixing apparatus 20a or the temperature of first fixing apparatus 20a is not less than the blank sheet cleaning permission temperature of 180° C.

In the third embodiment, there is no bypass conveyance path branched off from first fixing apparatus 20a, and consequently, a sheet used for cleaning by blank sheet should always be passed through both first fixing apparatus 20a and second fixing apparatus 20b. Therefore, cleaning by blank sheet is initiated when the temperature of the fixing apparatus in which a sheet is retained has reached the blank sheet cleaning permission temperature of the fixing apparatus. For example, in the case wherein no sheet is retained at first fixing apparatus 20a and a sheet is retained at second fixing apparatus 20b, cleaning by blank sheet can be initiated when the temperature of second fixing apparatus 20b has reached the blank sheet cleaning permission temperature of at least 165° C. regardless of the temperature of first fixing apparatus 20a.

The first to third embodiments have been described. However, the contents described in the above described embodiments are only suitable examples of the image forming system of the present invention and are not limited to these embodiments. For example, a configuration of two fixing apparatuses arranged in series was used in the explanation of the embodiments. However, it is needless to say that a configuration of three or more fixing apparatuses arranged in series can be applied. Further more, applicable type of fixing apparatus is not limited to a belt type, and a heat roller type is also applicable.

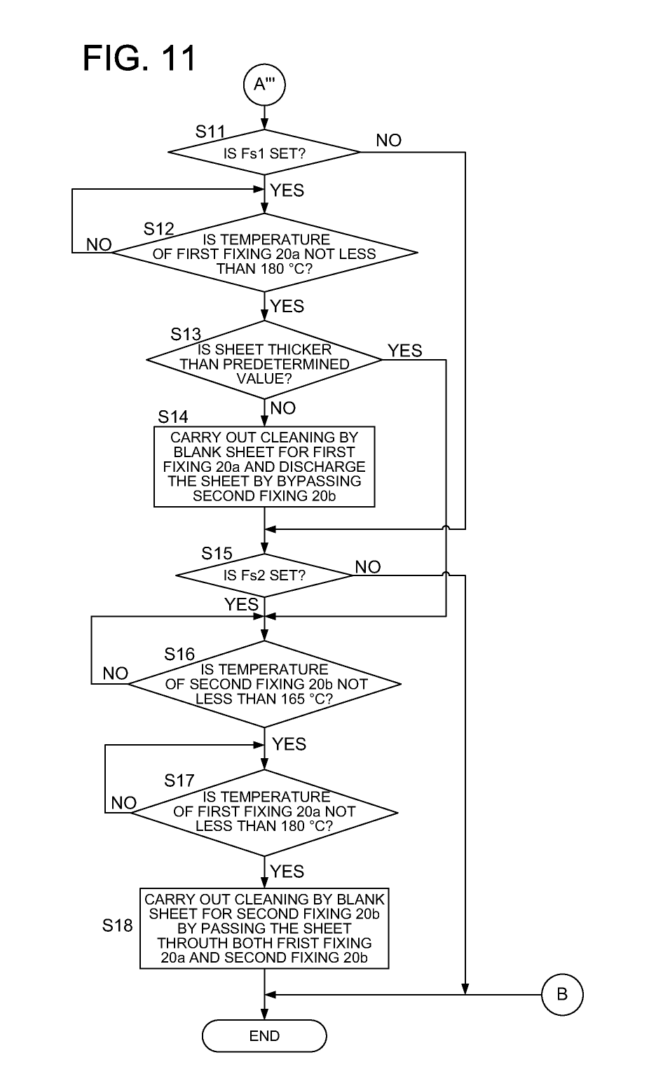

Next a forth embodiment of the present invention is described. In the embodiment, cleaning by blank sheet is carried out in a fixing apparatus, in which there is a possibility that a sheet is retained, one by one in a sequential manner, so that a sheet used for cleaning by blank sheet for the fixing apparatus will not contaminate other fixing apparatuses. FIG. 6 and FIG. 11 are each a flowchart showing the control program of the present invention, run by control section CU, from an occurrence of jam until execution of cleaning by blank sheet. Herein, the wordings in each flowchart are simplified.

At the moment when a jam occurs, this program is initiated. Initially, in step S01, the apparatus is shut down. Then, from a signal from sheet sensor SS on shutdown, whether or not a sheet is retained in first fixing apparatus 20a is judged (step S02). When a sheet is present therein, sheet retention flag Psi for first fixing apparatus 20a is set (step S03). In contrast, when no sheet is present, sheet retention flag Fs1 for first fixing apparatus 20a is cleared (step S04).

In the same manner, whether or not a sheet is retained in second fixing apparatus 20b is judged. Based on the presence or absence of a sheet, sheet retention flag Fs2 for second fixing apparatus 20b is set or cleared (steps S05 to S07).

Then, at step S08, the completion of jam treatment by the user is awaited, and then after completion, the temperature control of first fixing apparatus 20a and second fixing apparatus 20b is initiated. At that time, control section CU outputs the above blank sheet cleaning permission temperatures to first fixing apparatus 20a and second fixing apparatus 20b to carry out control for the relevant temperatures.

Subsequently, at step S10, whether or not cleaning by blank sheet is carried out is confirmed to the user. The user can visually observe the contamination state of the fixing apparatus in jam treatment, whereby in the case of little contamination occurrence, transition to normal formation of an image can be made without cleaning by blank sheet.

This confirmation is made under the condition that either sheet retention flag Fs1 for first fixing apparatus 20a or sheet retention flag Fs2 for second fixing apparatus 20b is set, namely, a sheet is retained in either of the fixing apparatuses. Display D1 of “EXECUTE CLEANING BY BLANK SHEET?” for operation panel SP and button display D2 of “YES” or “NO” for the touch panel section are carried out. When the pressed button is for “NO”, the advance of B in FIG. 6→B in FIG. 7 is made to terminate the present program.

When the pressed button is for “YES”, the advance to A′″ in FIG. 11 is made in stead of the advance to A in FIG. 7, and made is judgment whether or not sheet retention flag Fs1 for first fixing apparatus 20a is in the set state at step S11. In comparison with FIG. 7, FIG. 11 includes additional steps for judgment of the thickness of a sheet to be used for cleaning by blank sheet and steps to avoid contamination of other fixing apparatuses by the sheet used for cleaning of a fixing apparatus.

In the case of “YES” at step S11, then the procedure waits until the temperature of first fixing apparatus 20a has reached the blank sheet cleaning permission temperature of 180° C. at step S12, and made is judgment whether or not the thickness of available sheet to be used for cleaning by blank sheet is especially thick (not less than Basic Weight of 300 g/m²) at step S13. This judgement is made, for example, by using information on the classification of sheet (Basic Weight) which is set for each tray of sheet feeding apparatus 10, the information is accessible via operation panel SP.

In the case of “NO” at step S13, the sheet is a normal sheet, and therefore, at step S14, cleaning by blank sheet for first fixing apparatus 20a is carried out and the sheet is discharged via bypass without passing through second fixing apparatus 20b. In the case of “YES” at step S13, the advance to step S16 is made to discharge the sheet, which is to be used for cleaning by blank sheet for first fixing apparatus 20a, by passing through second fixing apparatus 20b. At step S16, the procedure waits until the temperature of second fixing apparatus 20b reaches the blank sheet cleaning permission temperature of at least 165° C. In the case of “YES” at step S16, it waits at step S17 until the temperature of first fixing apparatus 20a reaches the blank sheet cleaning permission temperature of at least 180° C. Step S17 is to avoid any possible damage to first fixing apparatus 20a by passing the sheet for cleaning while first fixing apparatus 20a is in a low temperature state in case the flow from step S11 to step S15 is made in the case of “NO” at step S11. At step S17, a lower temperature such as the previously explained rotation permission temperature may be used in stead of the blank sheet cleaning permission temperature. In the case of “YES” at step S17, cleaning by blank sheet for first fixing apparatus 20a is carried out by passing the sheet through both first fixing and second fixing apparatuses 20a and 20b.

In the case of “NO” at step S11, or after completion of cleaning by blank sheet for first fixing apparatus 20a and discharging of the sheet by bypassing second fixing apparatus 20b, the advance to step S15 is made, and then the determination for cleaning by blank sheet for second fixing apparatus 20b is made. Namely, made is judgment whether or not sheet retention flag Fs2 for second fixing apparatus 20b is in the set state at step S15.

In the case of “YES” at step S15, the advance to step S16 is made, and the procedure waits until the temperature of second fixing apparatus 20b reaches the blank sheet cleaning permission temperature of at least 165° C. When the temperature of second fixing apparatus 20b has reached the blank sheet cleaning permission temperature, then, at step S17, the procedure waits until the temperature of first fixing apparatus 20a reaches the blank sheet cleaning permission temperature of at least 180° C. As previously explained, step S17 is to avoid any possible damage to first fixing apparatus 20a by passing the sheet for cleaning while first fixing apparatus 20a is in a low temperature state in case the flow from step S11 to step S15 is made in the case of “NO” at step S11. In the case of “YES” at step S17, cleaning by blank sheet for second fixing apparatus 20b is carried out by passing the sheet through both first fixing and second fixing apparatuses 20a and 20b, and the present program is terminated.

As described above, in the embodiment of the present invention, cleaning by blank sheet is carried out in the fixing apparatuses, in which there is a possibility that a sheet is retained, one by one in a sequential manner so that the sheet used for cleaning by blank sheet for the fixing apparatus will not contaminate other fixing apparatuses.

The fourth embodiment has been described, however, the content described in the above described embodiment is suitable examples of the image forming system of the present invention and it is not limited to the embodiment. For example, a configuration of two fixing apparatuses arranged in series was used in the explanation of the embodiment. However, it is needless to say that a configuration of three or more fixing apparatuses arranged in series can also be applied. If three or more fixing apparatuses are arranged, the control section controls operation of cleaning by blank sheet in the fixing apparatuses, in which there is a possibility that a sheet is retained, one by one from the one which is located most upstream in a sequential manner, and the control section controls the sheet used for cleaning to be branched off to the bypass conveyance path to discharge the sheet without passing the sheet through one or the plurality of fixing apparatuses located downstream so that the sheet used for cleaning by blank sheet for the fixing apparatus will not contaminate other fixing apparatuses downstream. In such a manner, the control section carries out cleaning by blank sheet to all of the fixing apparatuses in which it has been determined that a sheet is retained without contaminating other fixing apparatuses by the sheet used for cleaning by blank sheet. Further more, applicable type of fixing apparatus is not limited to a belt type, and a heat roller type is also applicable.

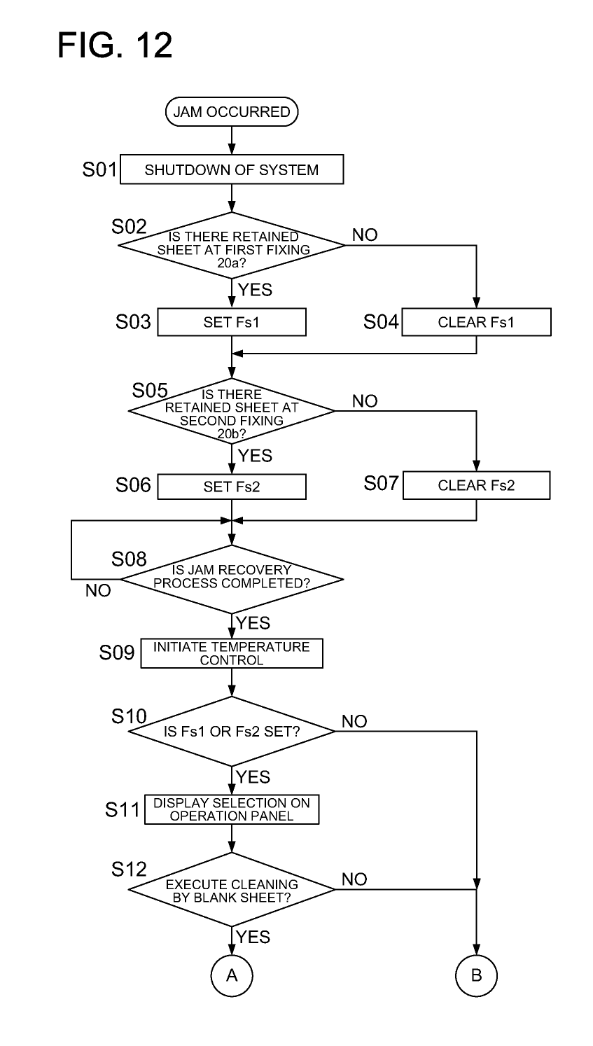

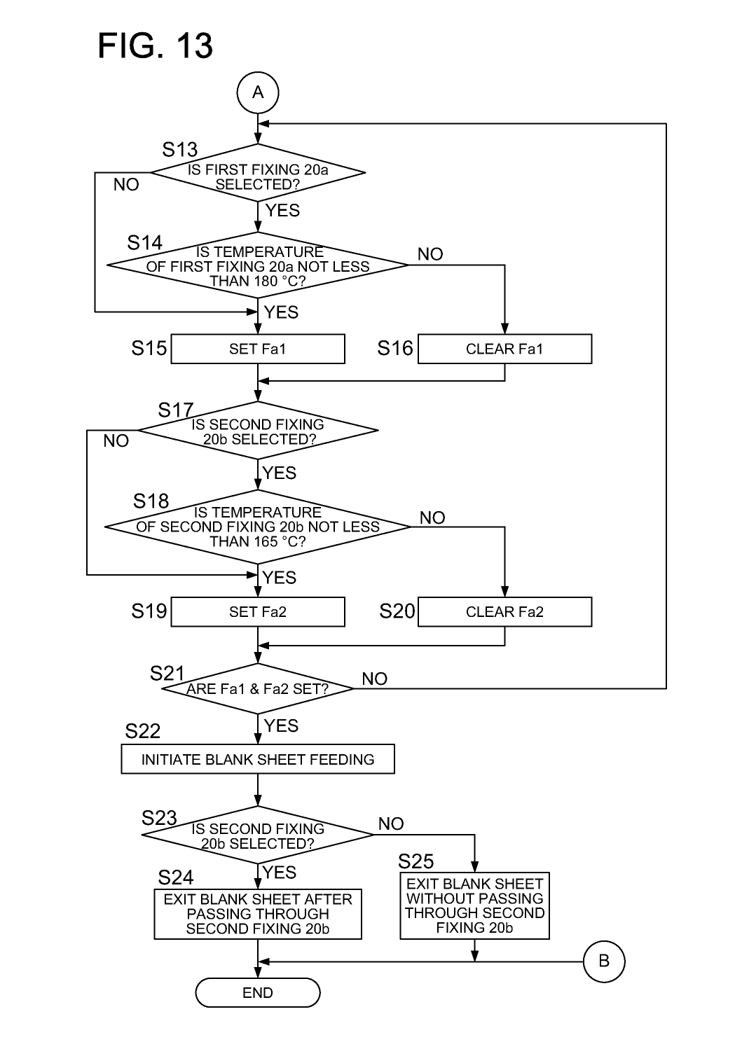

FIGS. 12 and 13 each are a flowchart showing the control program carried out by control section CU from jam occurrence to cleaning by blank sheet in a fifth embodiment of the present invention. In the fifth embodiment, if there is a possibility that a sheet is retained at a fixing apparatus when a jam occurs, confirmation to the user is made by using screens on operation panel SP such that whether or not cleaning by blank sheet is to be carried out, for which fixing apparatus the cleaning is to be carried out, and the selection of the number of sheets and type of a sheet to be used for cleaning by blank sheet. Thus, an efficient and economical cleaning by blank sheet is attained. Because steps up to step S09 in FIG. 12 are the same as those in FIG. 6, explanation for those steps is omitted and flow after step S10 is explained below. Herein, the wordings in each flowchart are simplified.

At step S10, made is judgment whether or not either one of sheet retention flag Fs1 for first fixing apparatus 20a or sheet retention flag Fs2 for second fixing apparatus 20b is set. If either one of the flags is set, the advance to step S11, which is a subroutine of display selection control of operation panel SP, is made. If neither one of the flags is set, the advance of B in FIG. 12→B in FIG. 13 is made to terminate the present program.

The subroutine of display selection control at step S11 is to confirm to the user whether cleaning by blank sheet is to be carried out, to which fixing apparatus cleaning by blank sheet is to be carried out, and the number of sheets and the type of a sheet to be used for the cleaning. The result of user confirmation is determined in this subroutine and provided to the control program of main routine of FIGS. 12 and 13.

Because the user can visually observe the state of contamination of the fixing apparatus during jam treatment, the user can transit to normal image forming operation without carrying out cleaning by blank sheet in the case of little contamination occurrence.

Confirmation of whether cleaning by blank sheet is carried out or not is made by displaying display D1 of “EXECUTE CLEANING BY BLANK SHEET?” for operation panel SP and button display D2 of “YES” or “NO” for the touch panel section as shown in FIG. 8.

It was explained that display D1 and display D2 in FIG. 8 are shown as the result of determination whether either one of sheet retention flag Fs1 for first fixing apparatus 20a or sheet retention flag Fs2 for second fixing apparatus 20b is set. However, as a transformative example, display D1 and display D2 in FIG. 8 can always be shown at any time when a jam occurs.

If usual sheet sensors are used to detect a jam occurrence without an arrangement of the previously described retention sensors which directly detect whether or not a sheet is retained in a fixing apparatus, there is a possibility that a sheet has reached a fixing apparatus and contaminated the fixing apparatus due to the arrangement positions of sheet sensors even if control section CU does not determine that a sheet is retained in the fixing apparatus. Also, there is a possibility that the user recognizes during jam treatment that fixing members are contaminated due to fixing operation up to the present time. For those cases, for example, it is effective to show the display D1 and display D2 in FIG. 8 at any time when a jam occurs.

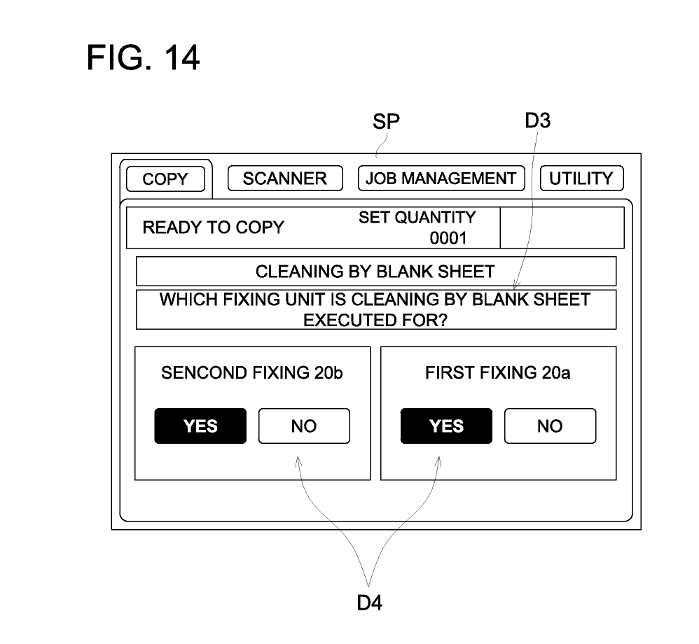

When the button display of “YES” in FIG. 8 is pressed, the advance to the display screen of operation panel SP shown in FIG. 14 is made, and confirmation to the user in which fixing apparatus cleaning by blank sheet is to be carried out is made by display D3 of “WHICH FIXING APPARATUS IS CLEANING BY BLANK SHEET EXECUTED FOR?” For each fixing apparatus, buttons of “YES” and “NO” are displayed, and “YES” is displayed by default for a fixing apparatus in which there is a possibility that a sheet is retained. In FIG. 9, the button of outline letters with black background is the default display.

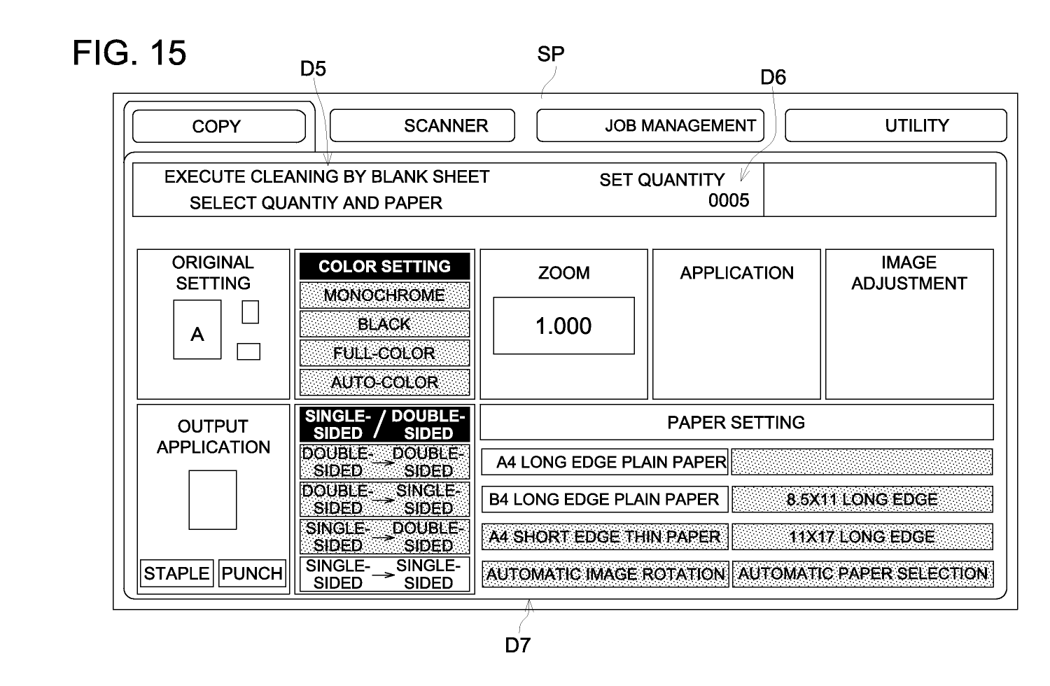

When either one of the buttons of “YES” is pressed, the transit to display screen in FIG. 15 is made, and the user confirms the number of sheets and the type of a sheet to be used for cleaning by blank sheet. This confirmation is made by display D5 of “EXECUTE CLEANING BY BLANK SHEET. SELECT QUANTITY AND PAPER”.

On the right-hand side of display D5, display D6 which is a default value of the number of sheets to be used for cleaning by blank sheet is displayed. If the user desires to change the default value, the user can change the number by inputting the desired number by using a numeric keypad (not shown) which is arranged next to operation panel SP, for example.

It is configured that an appropriate number of sheets is displayed as the default value in accordance with the state of fixing apparatuses in which there is a possibility of sheet retention. For example, if there is a possibility that a sheet is retained in both first fixing apparatus 20a and second fixing apparatus 20b, the number of sheets of “5” is displayed as the default, if there is a possibility that a sheet is retained in first fixing apparatus 20a upstream, the number of sheets of “3” is displayed as the default, and if there is a possibility that a sheet is retained at second fixing apparatus 20b downstream, then the number of sheets of “2” is displayed as the default. The user may adjust the default value to an appropriate number judging from the contamination level of the fixing apparatuses through visual confirmation.

Below display D5, screens for selecting various settings are displayed. Those screens are displayed in a manner such that the user can distinguish only selectable items. In this embodiment, buttons displayed by a dot pattern background are not user selectable items, and buttons displayed by white background are user selectable items. For example, all buttons in the area of color setting are not user selectable because no image formation is made.

In the setting area of “SINGLE-SIDED/DOUBLE-SIDED”, the button of “SINGLE-SIDED→SINGLE-SIDED” is only displayed by white background as selectable item and other buttons are not selectable because only single-sided sheet conveyance is used for cleaning by blank sheet.

At setting area D7 for sheet selection, only buttons for selectable sheets are displayed by white background. In the embodiment, as an example, the button for “A4 LONG EDGE PLAIN PAPER” and the button for “B4 LONG EDGE PLAIN PAPER” are displayed as selectable, and the button for “A4 SHORT EDGE THIN PAPER” is displayed as non-selectable because the thickness of the thin paper stored in a sheet tray is not suitable for cleaning by blank sheet.

The display control such as the display of selectable items or non-selectable items is automatically carried out by control section CU by comparing data, of the type of a sheet stored in sheet tray, with criteria which are predetermined and provided to control section CU.

One of the predetermined criteria is the type of a sheet which is used before a jam is occurred. For example, if A4 long edge sheet was used before jam occurrence, a sheet which is larger than or equal to A4 long edge sheet should be selected. Also, the type of a sheet such as a label sheet or an OHP is not suitable to cleaning by blank sheet and should be a non-selectable item.

When selections by the user in FIGS. 8, 14 and 15 are completed, the advance to step S12 of the main routine shown in FIG. 12 is made. Then, based on judgment whether or not cleaning by blank sheet is to be carried out, either the advance to step S13 in FIG. 13 is made or the advance is made to terminate the present program.

At step S13, made is judgment whether or not cleaning by blank sheet is to be carried out in first fixing apparatus 20a. If the result is “YES”, made is judgment whether or not the temperature of first fixing apparatus 20a has reached the blank sheet cleaning permission temperature of at least 180° C.

If “YES” at step S14, blank sheet cleaning permission flag Fa1 for first fixing apparatus 20a is set (step S15), and if “NO” at step 14, blank sheet cleaning permission flag Fa1 is cleared (step S16).

Similarly, made is judgment whether or not cleaning by blank sheet in second fixing apparatus 20b is selected at step S17, and if “YES”, made is judgment whether or not the temperature of second fixing apparatus 20b has reached the blank sheet cleaning permission temperature of at least 165° C. at step S18. If “YES” at step S18, blank sheet cleaning permission flag Fa2 for second fixing apparatus 20b is set (step S19), and if “NO”, blank sheet cleaning permission flag Fa2 is cleared (step S20).

Then, at step S21, the procedure waits until each of blank sheet cleaning permission flags Fa1 and Fa2 for first fixing apparatus 20a and second fixing apparatus 20b respectively is in the set state. Then, the advance to step 22 is made and feeding of a blank sheet is initiated.

The state wherein both blank sheet cleaning permission flags Fa1 and Fa2 are in the set state is the state wherein the temperature of first fixing apparatus 20a has reached at least 180° C. if there is a sheet retained in first fixing apparatus 20a, and the temperature of second fixing apparatus 20b has reached at least 165° C. if there is a sheet retained in second fixing apparatus 20b. At the state, cleaning by blank sheet is initiated even if the temperature of another fixing apparatus has not reached the control temperature, namely, the blank sheet cleaning permission temperature.

When cleaning by blank sheet is initiated at step S22, made is judgment at step 23 which fixing apparatus is selected in FIG. 14. If second fixing apparatus 20b is selected, then made is judgment whether the sheet for cleaning is to be passed through second fixing apparatus 20b (step S24) or not (step S25), and the flowchart is completed. According to the determination at step S23, control section CU controls the discharging of the sheet either by straight exit or by bypass exit.

As described above, in the present invention, it is configured that, when there is a possibility in which a sheet is retained in a fixing apparatus, the user is able to confirm and select by the screens of operation panel SP whether cleaning by blank sheet is to be carried out or not, in which fixing apparatus the cleaning is to be carried out, how many sheets are to be used for the cleaning, and what type of a sheet is to be used for the cleaning. By this configuration, an efficient and economical cleaning by blank sheet can be attained because unnecessary cleaning can be avoided and, if the cleaning is carried out, it is carried out by using an appropriate sheet conveyance path and by an appropriate number and type of sheet.

The above embodiment of the present invention has been described, however, the content described in the above described embodiment is suitable examples of the image forming system of the present invention and it is not limited to the embodiment. For example, a configuration of two fixing apparatuses arranged in series was used in the explanation of the embodiments. However, it is needless to say that a configuration of three or more fixing apparatuses arranged in series can also be applied. Also, it is not limited to the series configuration of fixing apparatuses. A configuration wherein a plurality of fixing apparatuses is arranged in parallel is also applicable. Further more, applicable type of fixing apparatus is not limited to a belt type, and a heat roller type is also applicable.

What is claimed is:

1. An image forming system comprising:
an image forming section;
a sheet feeding apparatus;
a plurality of fixing apparatuses located downstream of the image forming section;
a temperature control section which measures and controls the temperature of each of the plurality of fixing apparatuses;
a sheet retention determination section which determines whether or not there is a possibility in which during a jam occurrence, a sheet is retained in the nip section of each of the plurality of fixing apparatuses; and
a control section which controls cleaning of a fixing apparatus by passing a blank sheet through the fixing apparatus,
wherein the control section carries out the cleaning, after a jam treatment is completed, of the fixing apparatus, in which it has been determined by the sheet retention determination section that there is a possibility of a sheet being retained, by passing a sheet through the fixing apparatus, the sheet fed from the sheet feeding apparatus when the temperature of the fixing apparatus is determined to have reached a first prescribed temperature based on an input from the temperature control section.

2. The image forming system in claim 1, wherein the control section carries out cleaning of the fixing apparatus, in which it has been determined by the sheet retention determination section that there is no possibility of a sheet being retained, by passing a blank sheet through the fixing apparatus, the sheet fed from the sheet feeding apparatus when the temperature of the fixing apparatus is determined, based on an input from the temperature control section, to have reached a second prescribed temperature which is lower than the first prescribed temperature.

3. The image forming system in claim 1, wherein said prescribed temperature is different from a fixable temperature of the fixing apparatus in which it has been determined by the sheet retention determination section that there is a possibility of a sheet being retained.

4. The image forming system in claim 1, wherein the second prescribed temperature is a rotation permission temperature of the fixing apparatus in which it has been determined by the sheet retention determination section that there is a possibility of a sheet being retained.

5. The image forming system in claim 1, wherein the control section controls a blank sheet, to be used for the cleaning, to be conveyed through the image forming section without forming an image on the sheet.

6. An image forming system comprising:
an image forming section;
a sheet feeding apparatus;
a plurality of fixing apparatuses located downstream of the image forming section;
one or a plurality of bypass conveyance paths which is located downstream of each of the plurality of fixing apparatuses, excepting for a fixing apparatus located most downstream, to branch off a sheet leading toward to a discharge opening;
a sheet retention determination section which determines whether or not there is a possibility in which during a jam occurrence, a sheet is retained in the nip section of each of the plurality of fixing apparatuses; and
a control section which controls cleaning of a fixing apparatus by passing a blank sheet through the fixing apparatus,
wherein the control section carries out cleaning of the fixing apparatus, in which it has been determined by the sheet retention determination section that there is a possibility of a sheet being retained, by passing a blank sheet through the fixing apparatus and the control section controls the sheet passed through the fixing apparatus to be branched off to one or the plurality of bypass conveyance paths to be discharged.

7. The image forming system in claim 6, wherein when the sheet retention determination section determines the number of fixing apparatus, in which a sheet is retained, is one, and if there is another one or a plurality of fixing apparatuses upstream of the fixing apparatus, the control section controls a blank sheet to be used for the cleaning of the fixing apparatus by passing the blank sheet through one or the plurality of fixing apparatuses upstream of the fixing apparatus, and if there is another one or a plurality of fixing apparatuses downstream, the control section controls the blank sheet used for the cleaning to be branched off to one or the plurality of bypass conveyance paths so that the blank sheet is discharged without passing through one or the plurality of fixing apparatuses downstream.

8. The image forming system in claim 6, wherein when the sheet retention determination section determines the number of fixing apparatus in which a sheet is retained is more than or equal to two, the control section controls cleaning by passing a blank sheet for the cleaning at first through the fixing apparatus being located most upstream among the fixing apparatuses determined to have a retained sheet, and the control section controls the blank sheet used for the cleaning to be branched off to one or the plurality of bypass conveyance paths to be discharged without passing the sheet through one or the plurality of fixing apparatuses downstream, and then, the control section carries out cleaning of the second most upstream fixing apparatus with a retained sheet, and in such a manner, the control section carries out cleaning of all the fixing apparatuses in which a sheet is retained.

9. The image forming system in claim 6, wherein the control section controls a blank sheet, to be used for cleaning, to be conveyed through the image forming section without forming an image on the sheet.

10. The image forming system in claim 6, wherein, if the thickness of a blank sheet to be used for cleaning is more than or equal to a prescribed thickness, the control section controls the blank sheet used for the cleaning of a fixing apparatus to be passed through one or the plurality of fixing apparatuses being located downstream of the fixing apparatus without using one or the plurality of bypass conveyance paths.

11. An image forming system comprising:
an image forming apparatus comprises a image forming section and a sheet feeding apparatus;
a plurality of fixing apparatuses located downstream of the image forming section;
a sheet retention determination section which determines whether or not there is a possibility in which during a jam occurrence, a sheet is retained in the nip section of each of the plurality of fixing apparatuses;
a control section which controls cleaning of a fixing apparatus by passing a blank sheet through the fixing apparatus, and
a selection section which enables the user of the image forming system to select whether or not cleaning, of the fixing apparatus in which it has been determined that there is a possibility of a sheet being retained, is to be carried out.

12. The image forming system in claim 11, wherein the selection section is displayed on a operation panel of the image forming apparatus and comprises a plurality of display selection screens to select displayed contents, and when a fixing apparatus has been determined by the sheet retention determination section that there is a possibility of a sheet being retained, the selection section displays a screen to select whether or not cleaning of the fixing apparatus is carried out.

13. The image forming system in claim 11, wherein the selection section displays a display selection screen on which an alternative display of whether or not cleaning by a sheet is carried out is displayed for each of the plurality of fixing apparatuses, and the selection section displays a display indicating execution of cleaning as a default of the fixing apparatus in which it has been determined that there is a possibility of a sheet being retained.

14. The image forming system in claim 11, wherein the selection section displays a screen which shows the number of sheets to be used for cleaning if cleaning is to be carried out, and the selection section controls a change to the default value of the number of sheets to be used for the cleaning based on whether the number of fixing apparatuses, in which it has been determined that there is a possibility of a sheet being retained, is one or more.

15. The image forming system in claim 11, wherein the selection section displays a sheet setting screen which shows the type of sheet, and the selection section controls to show one or more available sheets for cleaning as a selectable variable.

16. The image forming system in claim 11, wherein the selection section displays the type of sheet shown as selectable based on the type of sheet which has been used before a jam occurrence as the criterion.

17. The image forming system in claim 11, wherein the selection section is equipped with a display selection screen which comprises a touch panel.

18. The image forming system in claim 11, wherein the control section controls a blank sheet, to be used for cleaning, to be conveyed through the image forming section without forming an image on the sheet.
